(19) United States
(12) Patent Application Publication
(10) Pub. No.: US 2020/0359569 A1
(43) Pub. Date: Nov. 19, 2020

(54) HUB AND SPOKE MODULAR FARM SYSTEM

(71) Applicant: Freight Farms, Inc., Boston, MA (US)

(72) Inventors: Brad MCNAMARA, Boston, MA (US); Jon FRIEDMAN, Boston, MA (US); Dan MARINO, Boston, MA (US); Derek BAKER, Boston, MA (US); Nigel SLATER, Boston, MA (US)

(21) Appl. No.: 16/987,150

(22) Filed: Aug. 6, 2020

Related U.S. Application Data
(63) Continuation of application No. PCT/US2019/017247, filed on Feb. 8, 2019.
(60) Provisional application No. 62/628,585, filed on Feb. 9, 2018.

(51) Int. Cl. A01G 9/029; A01G 9/24

(52) U.S. Cl. CPC A01G 9/0295; A01G 9/0293; A01G 27/003; A01G 9/247; A01G 9/249; A01G 9/246

(57) ABSTRACT

A modular farm system is provided having a hub container and pluralities of farm containers connectable to the hub container. A passageway is provided between the hub container and each farm container. The hub container includes a shared workspace and at least one shared utility for distribution among the farm containers. Each farm container includes a work zone and a grow zone. A plurality of plant panels and a lighting system are mounted for growing plants in a controlled environment within the grow zone.

### CROSS-REFERENCE TO RELATED APPLICATIONS

This application is a continuation of PCT application No. PCT/US2019/017247, which was filed on Feb. 8, 2019, and claims priority under 35 U.S.C. § 120 of U.S. Provisional Application No. 62/628,585, entitled Hub and Spoke Modular Farm System, filed on Feb. 9, 2018, the disclosures of which are incorporated by reference herein.

### BACKGROUND

The need for fresh food is growing as the population increases and changes in the climate impact growing seasons. The current food supply model, based on traditional farming methods and long distance shipping, is economically and environmentally unsustainable. Traditional farming operations are usually located in agricultural areas, which require large upfront costs and large acreage and have high operational costs from seed to sale.

Urban and local agriculture also faces obstacles. Growing space in urban areas is limited and not sufficient to meet a high demand. High start-up and operating costs of greenhouses make local crop production difficult for many businesses. Structures intended to support rooftop greenhouses must be evaluated by structural engineers and often require additional bracing to support the weight. Urban gardens often must address contaminated soil. Hydroponics systems are not easily used in urban locales, as most hydroponic systems are meant to be installed in agricultural settings, are not easily transportable, and require extensive training of personnel for operation.

Contained agricultural systems have recently been developed to address these issues. For example, a growing system in a modular container, described in U.S. Pat. No. 9,288,948, has been developed for generating high-yield crops. Within the modular container, the growing system includes a germination station for nurturing seeds until they germinate into plants, a plurality of vertical racks to hold the growing plants, a lighting system to provide appropriate light for the plants, an irrigation system to provide nutrients to the plants, a climate control system to control the environmental conditions within the container, and a ventilation system for providing airflow to the plants.

### SUMMARY

A modular farm system for efficient plant production is provided having a hub or centralized container and a plurality of farm containers that each extend outwardly from the hub container.

In some embodiments, a modular farm system includes a hub container and a plurality of farm containers connectable to the hub container, preferably with a user accessible passageway between the hub container and each farm container. The hub container includes a shared workspace and preferably also includes at least one shared utility associated with the hub container or located therein for distribution among the plurality of farm containers. Each farm container may include a work zone and a grow zone located therein, a plurality of plant panels mounted for growing plants within the grow zone, and a lighting system disposed in the grow zone to provide light for plants growing in the plant panels.

The modular farm system can have a variety of hub and spoke or branched configurations. In some embodiments, each of the hub container and the farm containers are rectangular in plan. The farm containers each have a shorter wall that can be disposed adjacent a longer wall of the hub container. Each of the farm containers can be disposed adjacent to another farm container, either with or without a space between farm containers.

Other embodiments and aspects include the following:

1. A modular farm system comprising:

a hub container, a plurality of farm containers connected to the hub container, and a user passageway between the hub container and each farm container, wherein:
the hub container includes a shared workspace and optionally at least one shared utility for distribution among the plurality of farm containers;
each farm container includes a work zone and a grow zone located therein, a plurality of plant panels mounted for growing plants within the grow zone, and a lighting system disposed in the grow zone to provide light for plants growing in the plant panels.
   2. The modular farm system of embodiment 1, wherein the work zone in one or more of said farm containers includes one or more of a seedling station, nutrient solution sensors, nutrient canisters, a control panel, and air handling unit.
   3. The modular farm system of any of embodiments 1-2, wherein the work zone in one or more of said farm containers includes a seedling station for the germination of seeds.
   4. The modular farm system of any of embodiments 1-3, wherein the shared workspace in the hub container includes one or more seedling stations for the germination of seeds.
   5. The modular farm system of any of embodiments 3 or 4, wherein the seedling station includes a trough to hold seedlings and a nutrient dosing system configured to provide a flow of a liquid nutrient solution to the seedlings in the trough.
   6. The modular farm system of any of embodiments 1-5, wherein the shared workspace in the hub container includes a packaging station including a work surface for packaging harvested mature plants from one or more of the plurality of farm containers.
   7. The modular farm system of any of embodiments 1-6, wherein the at least one shared utility of the hub container includes a climate control system comprising a split air conditioning and heating system including a condensing unit disposed at the hub container and an air handling unit disposed at each of the plurality of farm containers.
   8. The modular farm system of embodiment 7, wherein the climate control system comprises a ductless system including conduits from the condensing unit to each of the air handling units, the conduits including a power cable and refrigerant tubing, or a ducted system including ductwork for a flow of conditioned air to each of the farm containers.
   9. The modular farm system of any of embodiments 1-8, wherein the at least one shared utility of the hub container includes an electrical power input hookup and wiring to each or a subset of the plurality of farm containers, the wiring distributed into at least two separate zones.
   10. The modular farm system of any of embodiments 1-9, wherein the at least one shared utility of the hub container includes an incoming water connection and outgoing drain connection, the water connection and the drain connection in fluid communication with an irrigation system in each farm container.
   11. The modular farm system of any of embodiments 1-10, wherein each farm container includes a plurality of plant panels arranged in rows extending a length of the farm container, and a plurality of light panels arranged in rows facing each of the rows of the plant panels.
   12. The modular farm system of embodiment 11, further comprising a suspension system in each of the plurality of farm containers configured to suspend one or both of the plurality of plant panels and the plurality of light panels.
   13. The modular farm system of embodiment 12, wherein the suspension system includes a trolley system to provide movement of at least a portion of the plant panels or the light panels or both a portion of the plant panels or the light panels.
   14. The modular farm system of any of embodiments 1-12, further comprising a movable mounting system for mounting at least one row of the plant panels and the at least one row of light panels for movement toward and away from an interior side wall of the farm container.
   15. The modular farm system of embodiment 14, wherein the movable mounting system comprising a suspension system including one or more cross rails extending across a width of an interior of the farm container, and the plant panels and the light panels are mounted for movement along the cross rails.
   16. The modular farm system of any of embodiments 14-15, wherein the movable mounting system further includes wheels disposed on a bottom of one or both of the plant panels and the light panels for movement across a floor of the farm container.
   17. The modular farm system of any of embodiments 1-16, wherein each plant panel comprises a plurality of adjacent, integrally formed elongated channels, and a mounting fixture disposed on a back wall of the plant panel configured to removably suspend the plant panel from the suspension system.
   18. The modular farm system of any of embodiments 1-17, further comprising an irrigation system within each farm container, the irrigation system including:

a nutrient solution reservoir disposed in the farm container;

an irrigation line disposed to deliver a liquid nutrient solution from the nutrient solution reservoir to an upper end of each plant panel; and

a pump in the nutrient solution reservoir connected to the irrigation line.

19. The modular farm system of embodiment 18, wherein the irrigation system further includes a plurality of emitters on the irrigation line, each emitter disposed above an elongated channel in each of the plant panels, each elongated channel having an open upper end to receive a liquid nutrient solution from an associated emitter.
20. The modular farm system of embodiment 19, wherein each elongated channel of the plant panels has an open lower end to discharge liquid nutrient solution to return to the nutrient solution reservoir.
21. The modular farm system of embodiments 18-20, wherein the irrigation system in each farm container is in fluid communication with an incoming water line having a input connection at the hub container and a drain line having an output connection at the hub container.
22. The modular farm system of any of embodiments 1-21, further comprising a nutrient dosing system in each of the plurality of farm containers, comprising:

a recirculation line disposed to recirculate a liquid nutrient solution from a nutrient solution reservoir,

a plurality of nutrient sources, and

a line from each nutrient source to the recirculation line to introduce a nutrient into the recirculation line.

23. The modular farm system of embodiment 22, wherein the nutrient dosing system further comprises a sensor assembly disposed to sense one or more of pH, electrical conductivity, and temperature of a liquid nutrient solution in the recirculation line.
24. The modular farm system of any of embodiments 1-23, further comprising a control system for automating control of a growing environment within each farm container, the control system including one or more processors and memory, and machine-readable instructions stored in the memory that, upon execution by the one or more processors cause the system to carry out operations comprising:

receiving communications from one or more of the plurality of farm containers, the communications including at least data from one or more of a sensor and equipment within the farm container; and

transmitting a communication to at least one of the farm containers comprising instructions or notifications regarding growing conditions within the contained environment.

25. The modular farm system of embodiment 24, wherein the control system is further operative to carry out operations including receiving communications from the hub container including at least data from one or more or a sensor and equipment within one or more of the farm containers, and transmitting a communication to a selected one of the farm containers through the hub container.
26. The modular farm system of embodiment 25, wherein the transmitted communication includes instructions to carry out operations comprising controlling and monitoring one or more of a lighting system, an irrigation system, and a climate control system within the farm container.
27. The modular farm system of any of embodiments 1-26, wherein each of the hub container and the farm containers are rectangular in plan and the farm containers each have a shorter wall disposed adjacent a longer wall of the hub container, each of the farm containers disposed with a longer wall adjacent to a longer wall of an adjacent farm container.
28. The modular farm system of any of embodiments 1-27, wherein the hub container extends for a linear distance, and the plurality of farm containers are disposed to extend orthogonally to the linear distance of the hub container on one or both sides of the hub container.
29. The modular farm system of any of embodiments 1-28, wherein the hub container has a polygonal configuration and the plurality of farm containers extending radially from sides of the polygonal configuration of the hub container.
30. The modular farm system of any of embodiments 1-29, further comprising an additional hub container connected to the hub container for user passage therethrough, and an additional plurality of farm containers connectable to the additional hub container, a user passageway between the additional hub container and each additional farm container.
31. The modular farm system of any of embodiments 1-30, further comprising two or more hub containers, each hub container connected via a passageway to each of a separate plurality of farm containers.
32. The modular farm system of embodiment 31, wherein the two or more hub containers are connected via one or more passageways.
33. The modular farm system of embodiments 31 or 32, wherein the system comprises two or more separate zones, each zone comprising one or more farm container or one or more hub containers, each with its associated farm containers, and wherein the separate zones are configured for different crops, different plant growth conditions, or different customers.
34. The modular farm system of embodiment 33, wherein the separate zones are configured for different growth conditions, and the different growth conditions differ according to lighting, temperature, nutrient solution, humidity, plant density, and/or CO₂ concentration.
35. A method of growing a crop, comprising:

providing the modular farm system of any of embodiments 1-34;

growing a crop within at least one of the plurality of farm containers.

36. The method of growing a crop of embodiment 35, further comprising germinating seedlings in a seedling station disposed in one or both of the shared workspace of the hub container or the work zone of the farm containers, and planting seedlings in the grow space in one or more of the plurality of farm containers.
37. The method of growing a crop of embodiments 35 or 36, further comprising harvesting a mature crop from one or more of the plurality of farm containers, and packaging the mature crop at a packaging station in the shared workspace of the hub container.
38. A modular farm system comprising:

a farm container;

a plurality of plant panels mounted for growing plants within the farm container, the plant panels disposed in at least one row;

a lighting system comprising a plurality of light panels disposed in at least one row to provide light for plants growing in the plant panels; and

a movable mounting system for mounting the at least one row of the plant panels and the at least one row of the light panels for movement toward and away from an interior side wall of the farm container.

39. The modular farm of embodiment 38, wherein the movable mounting system comprising a suspension system including one or more cross rails extending across a width of an interior of the farm container, and the plant panels and the light panels are mounted for movement along the cross rails.
40. The modular farm of any of embodiments 38-39, wherein the movable mounting system further includes wheels disposed on a bottom of one or both of the plant panels and the light panels for movement across a floor of the farm container.

### DESCRIPTION OF THE DRAWINGS

Reference is made to the following detailed description taken in conjunction with the accompanying drawings in which:

FIG. 1 is an isometric view of an embodiment of a modular farm system;

FIG. 2 is a top plan view of the modular farm system of FIG. 1;

FIG. 3 is a further isometric view of the modular farm system of FIG. 1;

FIG. 4 is a further isometric view of the modular farm system of FIG. 1;

FIG. 5 is an isometric view of a further embodiment of a modular farm system;

FIG. 6 is a top plan view of the modular farm system of FIG. 5;

FIG. 7 is an isometric view of one farm container of the modular farm system of FIG. 5;

FIG. 8 is a top plan view of the farm container of FIG. 7;

FIG. 9 is an isometric view of a still further embodiment of a modular farm system;

FIG. 10 is a top plan view of the modular farm system of FIG. 9;

FIG. 11 is an isometric view of one farm container of the modular farm system of FIG. 9;

FIG. 12 is a top plan view of the farm container of FIG. 11;

FIG. 13 is a partial front view of an embodiment of a plant panel;

FIG. 14 is an isometric front view of an embodiment of a plant panel containing plants;

FIG. 15 is an isometric rear view of the plant panel of FIG. 14;

FIG. 16 is a rear view of the plant panel of FIG. 14;

FIG. 17 is a top plan view of the plant panel of FIG. 14 without plants;

FIG. 18 is an enlarged view of the plant panel illustrated in FIG. 17;

FIG. 19A is a top plan view of an embodiment of a farm container showing center plant panels and light panels moved to one side to create a large central workspace; FIG. 19B is an isometric view of the farm container shown in FIG. 19A;

FIG. 20 is an illustration of a pair of light panels, with the panels each containing 10 LED light strips, alternating red (R) and blue (B) color as shown; and

FIGS. 21A-21D are schematic representations of various layouts of hub and spoke modular farm systems.

### DETAILED DESCRIPTION

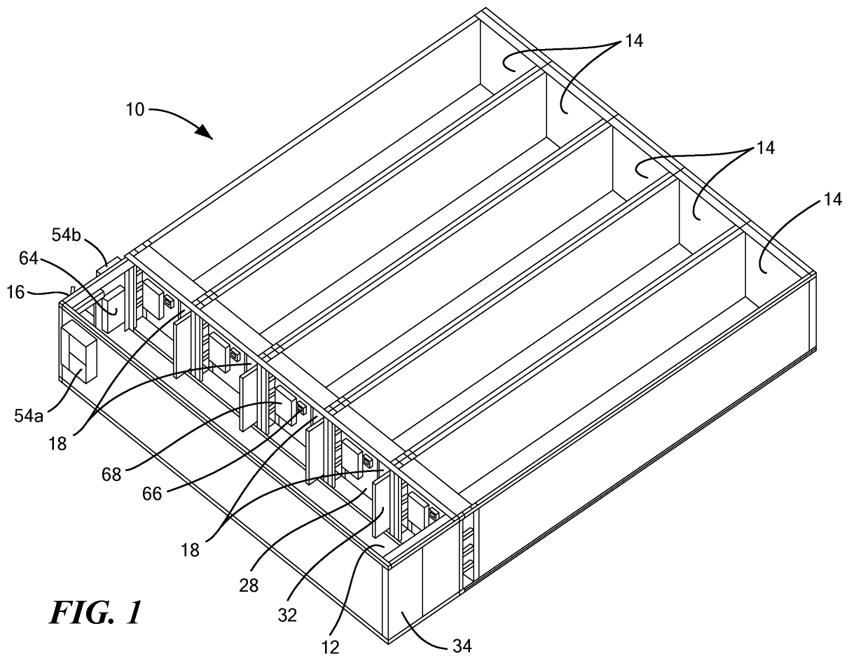

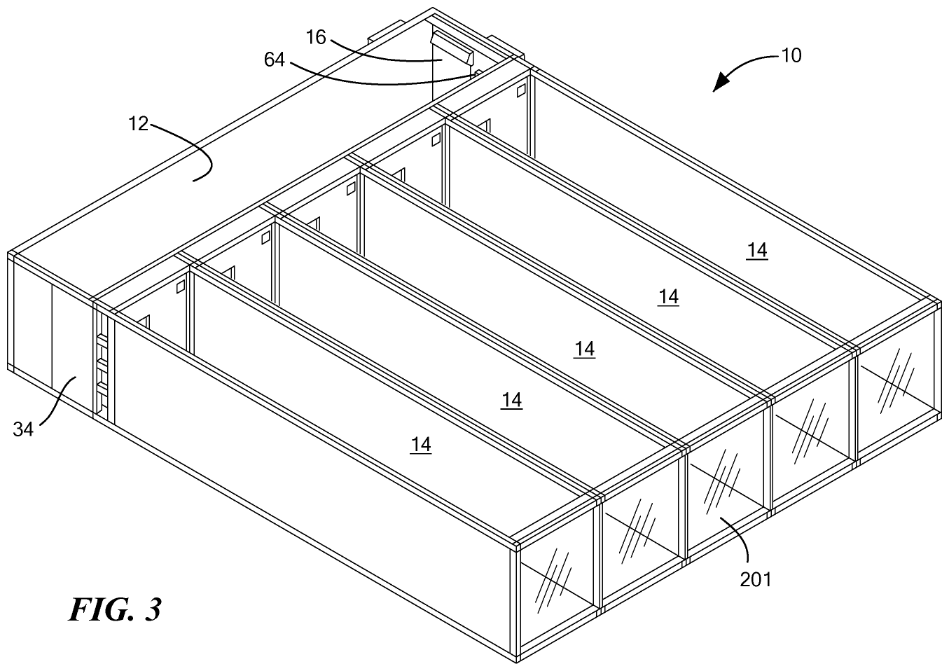

Referring to FIGS. 1-4, a modular farm system 10 with a hub and spoke or branched configuration is provided. The system includes a hub container 12 and two or more farm containers 14 connected to and accessible via the hub container. Each farm container 14 provides a space for growing crops hydroponically in a controlled environment. The hub container 12 can house shared equipment and work spaces and can provide for the distribution of some utility systems and consolidation of some farm activities, described further below. A main entrance 16 for user access to the modular farm system is provided in the hub container. From the interior of the hub container, a passage 18 for user access is provided into each connected farm container.

Within the modular farm system, an entire growth cycle of one or more crops can be handled by the farmer. All tasks involved in growing a crop, from planting and germinating seeds to transplanting seedlings into the grow zone, growing the plants to maturity, harvesting the crop, and packaging the crop for shipment can be performed in the farm container and/or the hub container, thereby improving work flow. The farmer does not have to walk long distances through a farm from one place to another and does not have to transport seedlings from a distant location.

In some embodiments, all of the farm containers 14 in a modular farm system can be used to grow a single crop. In some embodiments, a different crop can be grown in each or a subset of the containers 14. In some embodiments, two or more crops can be grown in a single farm container 14. The configuration can provide an efficient use of space, energy, and farmer time and can increase crop density and yield, and can provide economies of scale. In some embodiments, the modular farm system can provide up to an 80% increase in the number of plant sites within a farm container. For example, in some embodiments, an 80% increase can be achieved by a plant panel allowing for tighter plant spacing, and planting multiple varieties, which can have various sizes, next to each other. In some embodiments, the modular farm system can provide up to a 25% decrease in energy use. In some embodiments, the modular farm system can provide a 15% to 30% reduction in labor.

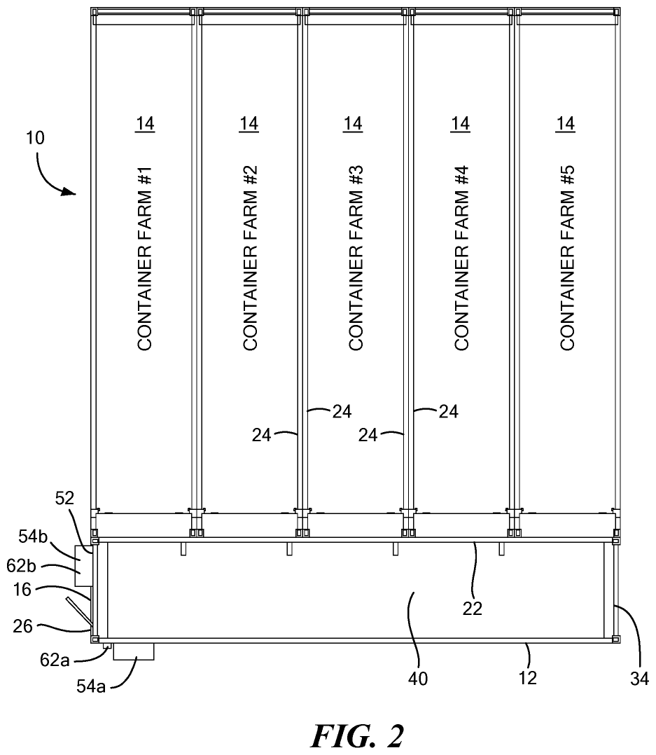

In the embodiment shown in FIGS. 1-4, the hub container 12 and the farm containers 14 are each rectangular. The farm containers are arranged to extend perpendicularly from a long wall 22 of the hub container 12 and abut each other along shared longer walls 24. See FIG. 2. Abutting the farm containers can increase thermal efficiency of the containers and can minimize use of insulation within the abutting walls. In some embodiments, farm containers can extend from both long walls of the hub container. A main entrance 16 for user access is provided in a shorter wall 26 of the hub container. From the interior of the hub container, a passage 18 for user access is provided into each connected farm container. See FIG. 1. Each passage 18 is formed by an opening in a short wall 28 of each farm container 14 aligned with an opening in the long wall 22 of the connected hub container. Suitable doors 32 can be provided to close the main entrance into the hub container and each passage into each farm container, so that the farm environments can be sealed to maintain appropriate growing conditions. An additional door can be provided at the opposite shorter wall 34 of the hub container, for example, to provide an emergency exit.

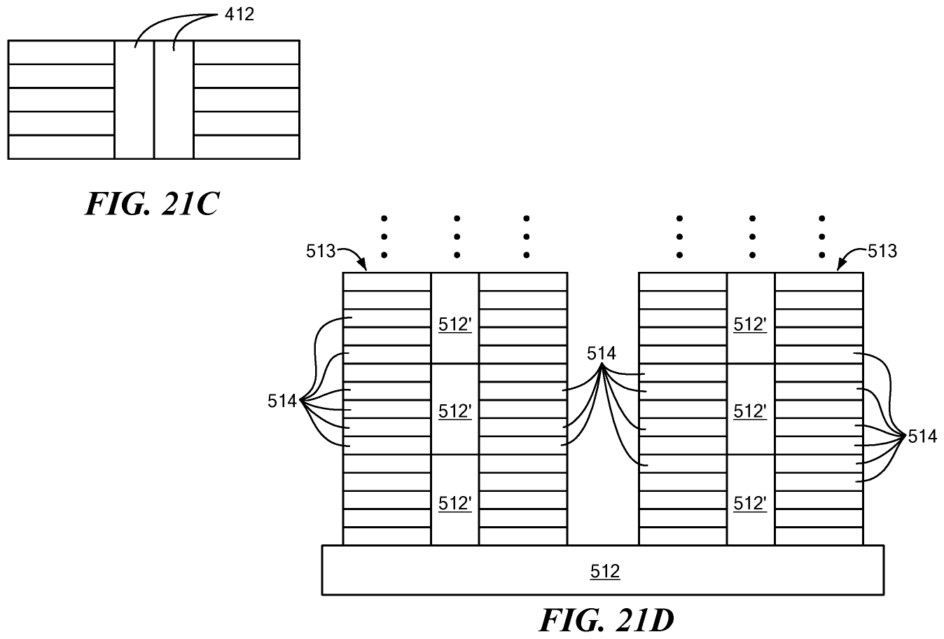

In the embodiment shown in FIGS. 1-4, the dimensions of all the containers (hub and farms) are the same and are selected so that all of the farm containers 14 fit along the long wall of the hub container 12, with the long walls 24 of the farm containers abutting. For example, each rectangular container can be 96 inches (8 feet) wide along the shorter wall and 480 inches (40 feet) long along the longer wall, resulting in five farm containers connected to the hub container. It will be appreciated that the containers can have other dimensions. For example, the dimensions do not need to be selected so that the length of the longer wall of a hub container is an exact multiple of the length of the shorter walls of the farm containers. Farm containers connected to a single hub container can have different lengths. In some embodiments, the farm containers can extend at different angles from the hub container. For example, a hub container 212 can have a polygonal or rounded configuration in plan view, such as triangular, pentagonal, hexagonal, or the like, and one or more farm containers can extend from each side wall of the hub container. See FIG. 21A. In some embodiments, two or more hub containers 312 can be connected together linearly along abutting shorter walls to form a longer or chained hub container assembly. See FIG. 21B. In some embodiments, two or more hub containers 412 can be connected together along abutting longer walls. See FIG. 21C. In some embodiments, a hub container or chain of hub containers can extend 25, 50, 75, or 100 or more yards in length. In some embodiments, a central hub container 512 can include several branches 513, and each branch can include one or more subsidiary hub containers 512′ to which container farms 514 connect. See FIG. 21D.

It will be appreciated that a variety of hierarchical branching or hub and spoke configurations can be used, as determined by, for example, the crop or crops desired to be grown, the scale of crop production desired, and the space in which the modular farm system is to be located. The special organization and flexibility of the modular farm system provides numerous options for expanding crop size and arranging harvesting schedules. For example, a single crop or selected group of crops can be grown and harvested in a synchronized cycle in 1, 2, 3, 4, 5, 6, 7, 8, 9, 10, 15, 20, 25, 30, 40, 50, 60, 70, 80, 90, or 100 or more farm containers. Synchronized scale-up can be useful for meeting the needs of individual customers, or can provide each of several different customers with a unique consolidated physical region of an extended modular farm system.

### 1. Hub Container Shared Work Space

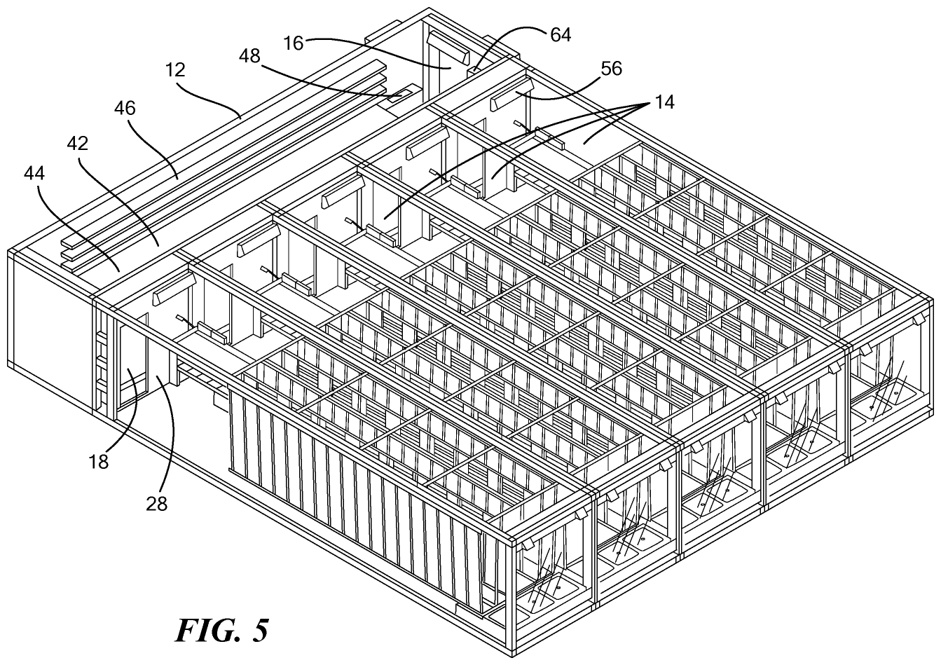

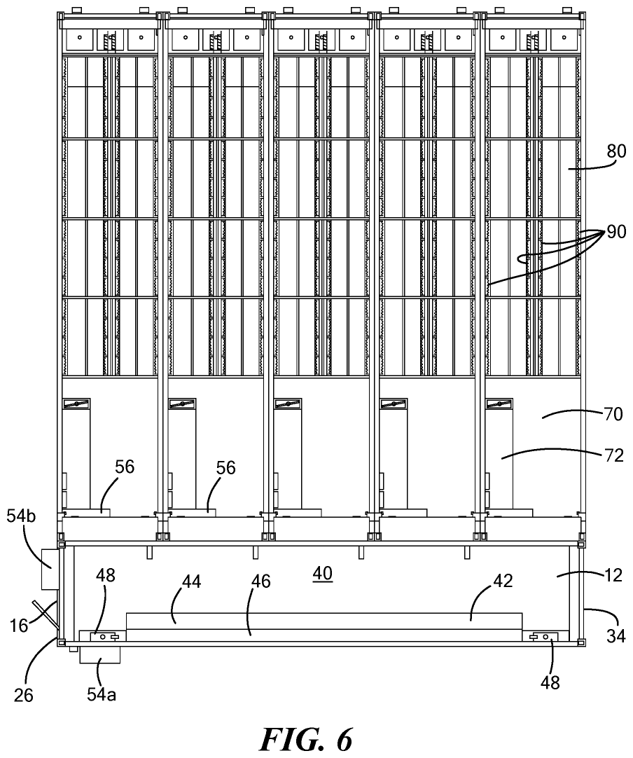

As noted above, the hub container 12 provide shared space 40 for activities and systems that can be shared among several farm containers 14. In some embodiments, a packaging station 42 can be provided at which crops harvested from the attached farm containers can be packaged for shipment, either from all attached containers at one time, or one or more containers at a time. See FIGS. 5, 6. A packaging station 42 can include a work surface 44, for example, that extends along a long interior wall of the hub container opposite the passages into the farm containers. The work surface can be used for any other desired tasks, as needed. Shelving 46 can be provided along the wall for storage of supplies or other items. A sink or sinks 48, for example, for hand washing or cleaning tools or other equipment, can be provided at a suitable location(s), such as one or both ends of the hub container. In some embodiments, one or more seedling stations (described further below) can be located in the hub container.

The hub container can also provide shared equipment for the farm containers. In some embodiments, the shared equipment can include various utilities for distribution among the plurality of farm containers. For example, an incoming water connection 52 and outgoing drain connection can be provided at the hub container. FIG. 2 shows an incoming water hookup on a short end wall of the hub container; however, other locations can be used. The water connection and drain connection can connect to an irrigation system within each farm container, described further below.

### 2. Climate Control or HVAC Systems

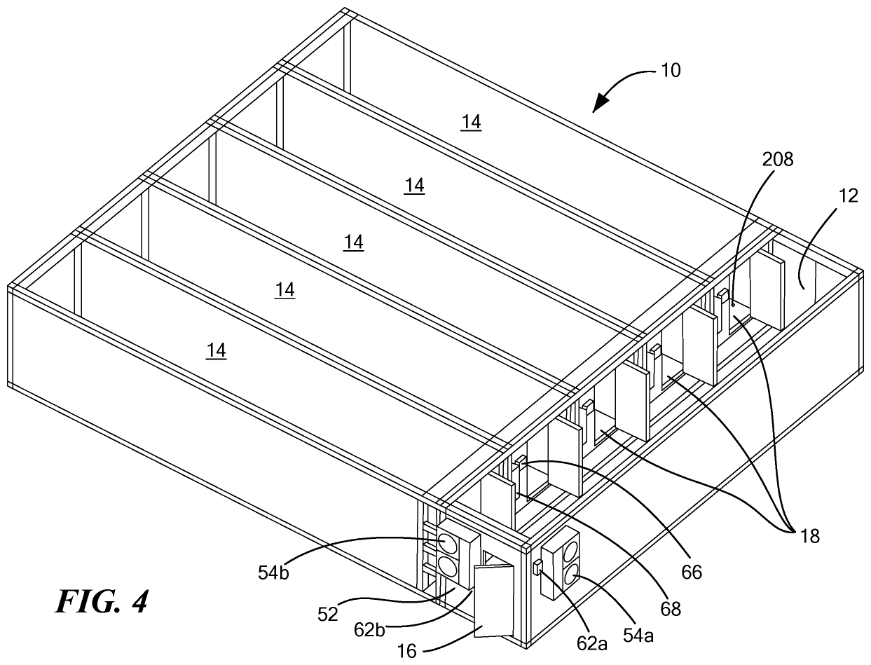

In some embodiments, a split air conditioning and heating system can be used. Each farm container or a subset of farm containers can be on its own zone. A condensing unit housing a condenser and compressor can be located in a unit outside of the modular farm system, such as on an exterior wall of the hub container. FIGS. 2 and 4 illustrate two possible locations for the condensing unit 54a, 54b. The condensing unit can be shared by each of the farm containers. An air handling unit 56 housing an evaporator and air fan can be located within each farm container. In some embodiments, the air conditioning and heating system can be a ductless system. Suitable conduits can run from the exterior condensing unit to each interior air handling unit, including power cables, refrigerant tubing, suction tubing, and a condensate drain. The conduits can be located within one or more access panels in the walls, floors, and ceilings of the hub container and the farm containers.

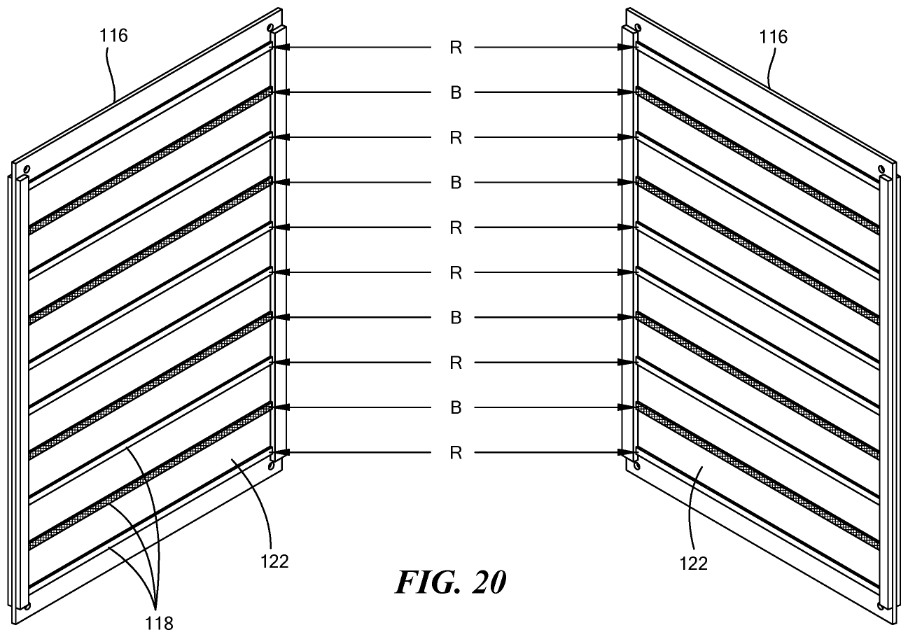

In some embodiments, a ducted split air conditioning and heating system can be provided, with suitable ductwork running from the hub container to the farm containers. In some embodiments, each farm container can be provided with its own dedicated air conditioning and heating system. In some embodiments, referring to FIG. 19B, an HVAC inlet 55 can be provided in a farm container. Air ducts 58 can be provided along the length of the farm container. One or more intake fans 57 and exhaust fans 59 can be provided at suitable locations, such as the ends of the farm container.

In some embodiments, an air conditioning unit can be located on the roof of one or more farm containers and/or on the roof of the hub container. A number of air registers can be located in the ceiling panel of each of the farm containers and the hub container. An exhaust cowl can also be located in the roofs. Climate sensors can be located within the farm containers and/or the hub container to sense parameters such as air temperature, humidity level, CO₂ level and air flow. In some embodiments, an intake air housing and supply fan can be located in each farm container. In some embodiments, fans can be oriented to blow air upwardly past the plants. In some embodiments, a CO₂ canister 51 can be provided to supply CO₂ when needed.

### 3. Electrical Systems

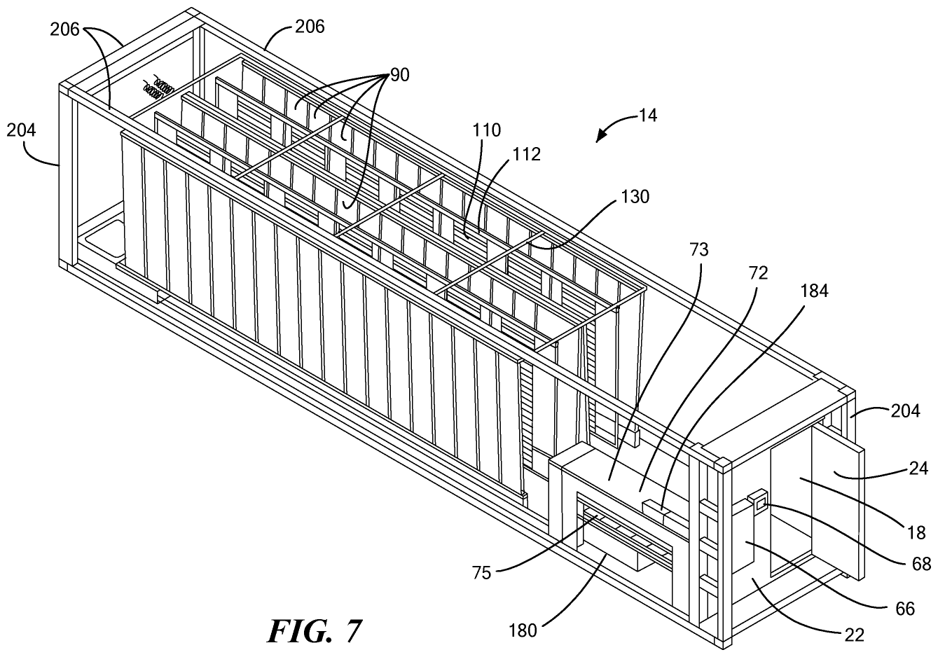

The electrical system provides incoming electricity to supply power to the various systems that run on electrical power. An electrical hookup can be provided on an exterior wall of the hub container to bring power to the modular farm system. FIGS. 2 and 4 illustrate two possible locations for the electrical hookup 62a, 62b. A main breaker box 64 can be provided on an interior wall of the hub container. In some embodiments, an electrical zone can be provided for each farm container or a subset of farm containers that is independent from the zones of the other farm containers and/or subsets of farm containers. Each farm container can include an electrical and control panel 66 located on a wall accessible from the shared space within the hub container. See FIGS. 1, 4, 7. In some embodiments, a touch screen or other panel 68 for entry of data, commands, instructions, or other information by a farmer can be provided, for example, at the entrance to a farm container. Wiring can be provided from the electrical hookup to each farm container's electrical and control panel. The wiring can run through access spaces within the walls and ceiling of the hub container and the farm containers.

### 4. Farm Containers

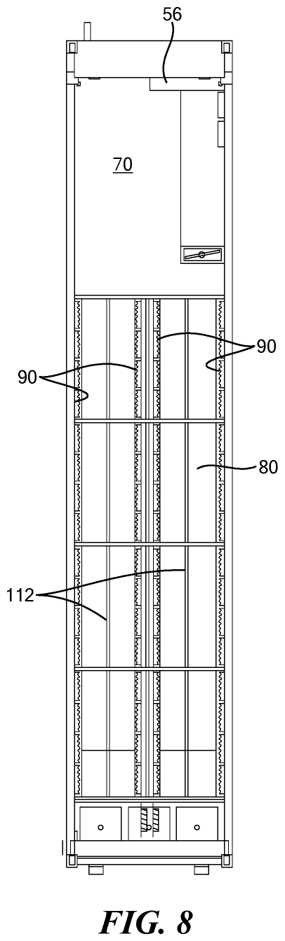

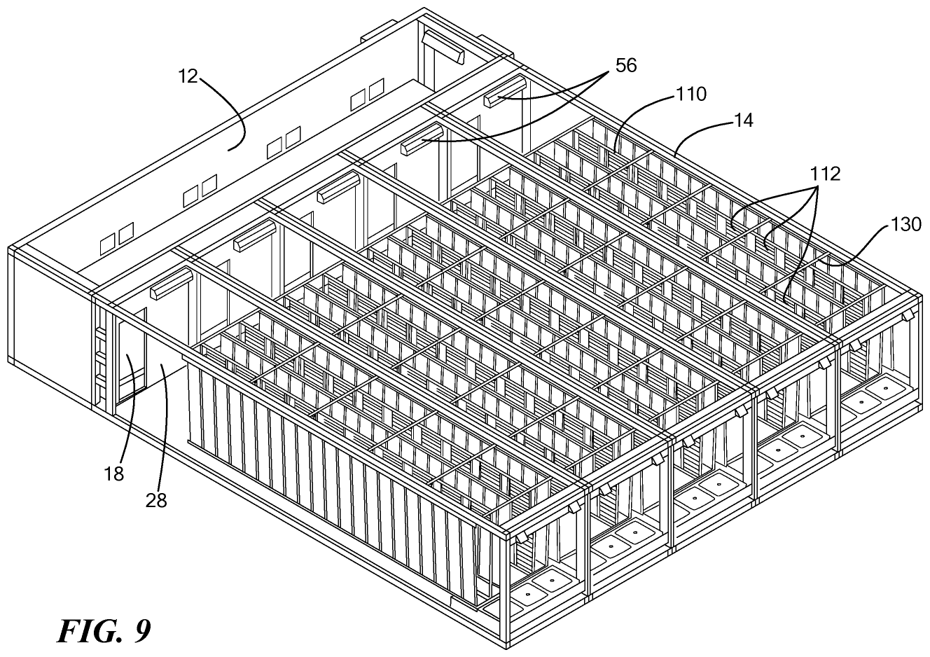

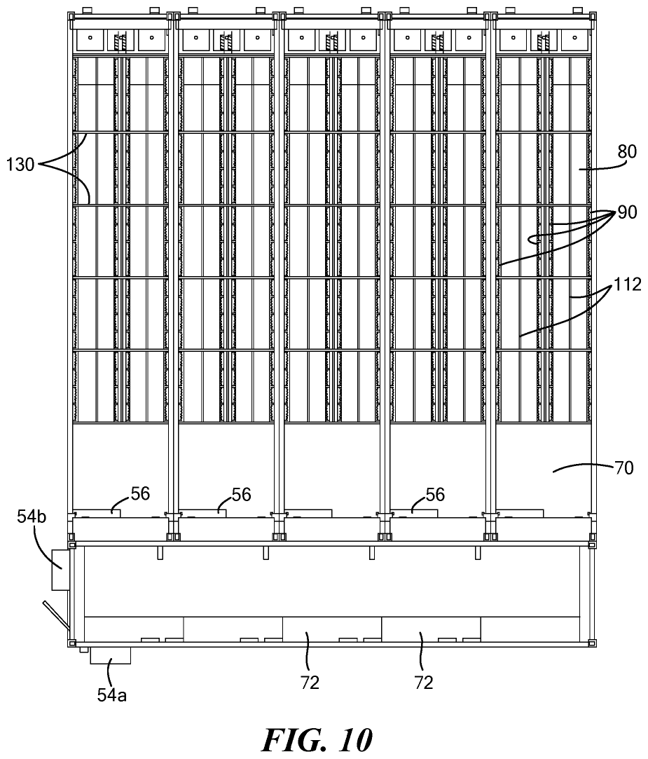

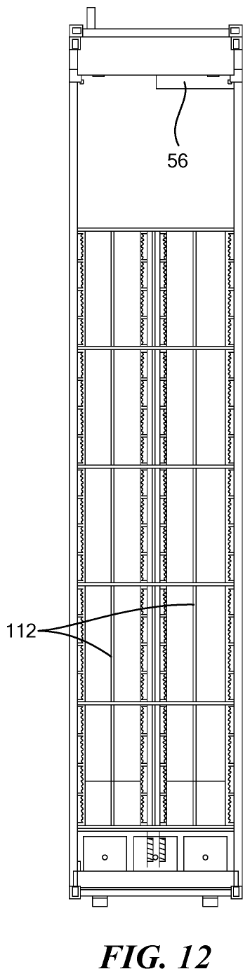

Each farm container 14 provides an enclosed space having a work zone 70 and a grow zone 80. In the grow zone, a plurality of plant panels 90 are mounted for growing crops to maturity in vertical columns. In the work zone, a work surface can be provided for tasks such as transplanting seedlings into the plant panels. A sink, for example, for hand washing or cleaning tools or other equipment, can be provided. In some embodiments, a seedling station for planting and germinating seeds (described further below) can be provided in the work zone within the growing container. FIGS. 5-8 illustrate an embodiment in which seedling tables 72 are provided in the work zone 70. FIGS. 9-12 illustrate an embodiment in which the work zone includes a preparation area and the seedling tables 72 are located within the hub container; a seedling table 72 is provided for each farm container. In some embodiments, the farm container can include one or more dividers to separate the container into a plurality of areas. In some embodiments, the plurality of areas can include one or more of a grow zone, a work zone, and an airlock operable to reduce contamination in the grow zone from outside of the farm container. The airlock can provide a farmer access to the work zone or the grow zone from outside of the farm container.

Various systems can be included within the farm containers to create a suitable environment for growing crops. The systems can include an irrigation system for providing a liquid nutrient solution to plants growing in the plant panels and in the seedling station. A lighting system can provide lighting of appropriate frequencies and schedules for the plants. A climate control system, for example, a heating, ventilation, and air conditioning or HVAC system, can provide an appropriate temperature, humidity level, CO₂ level, and air flow. As noted above, connections to these systems can be provided through the farm container walls from the hub container, for example, to bring water, electricity, and HVAC conduits into the farm containers to supply and operate the various systems.

Referring to FIGS. 5-12, in some embodiments, the plurality of plant panels are arranged in four rows extending the length of the containers within the grow zone. Two outer rows extend along each long wall with the plants facing inwardly toward the center. Two center rows extend along the center of the grow zone in a back-to-back arrangement with the plants facing outwardly toward the outer rows. A row of light fixtures is located between each pair of rows of facing plants.

### 5. Plant Panels

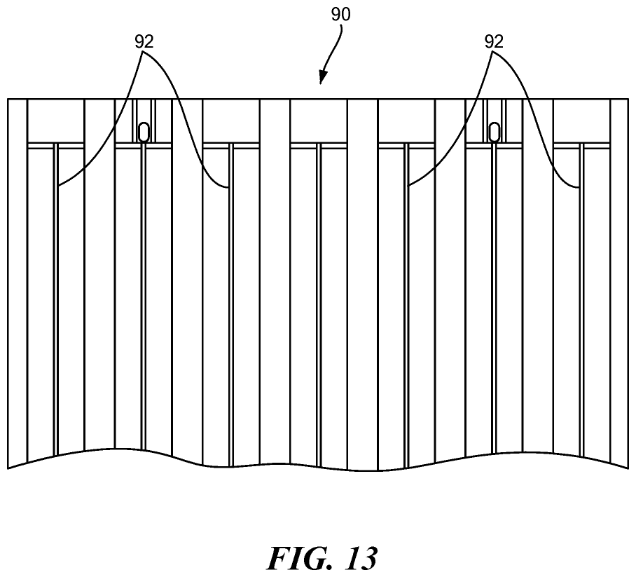

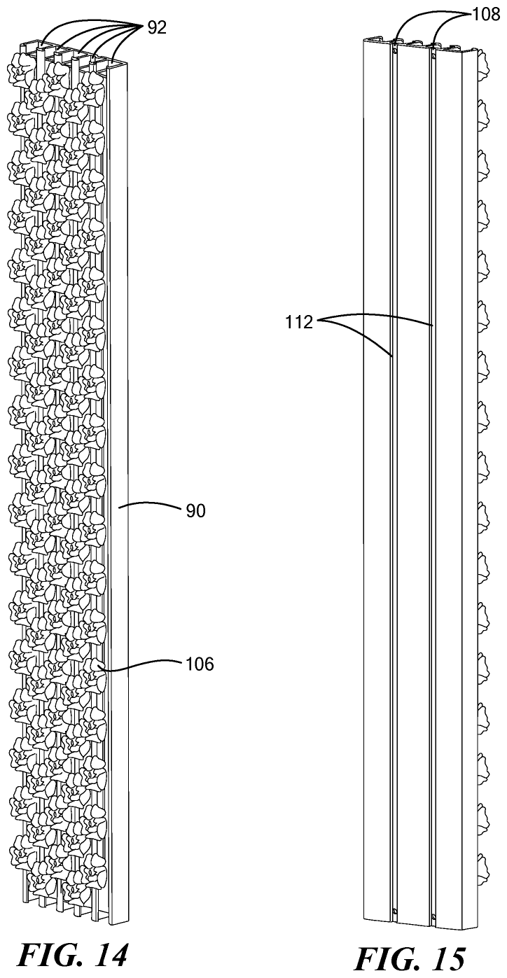

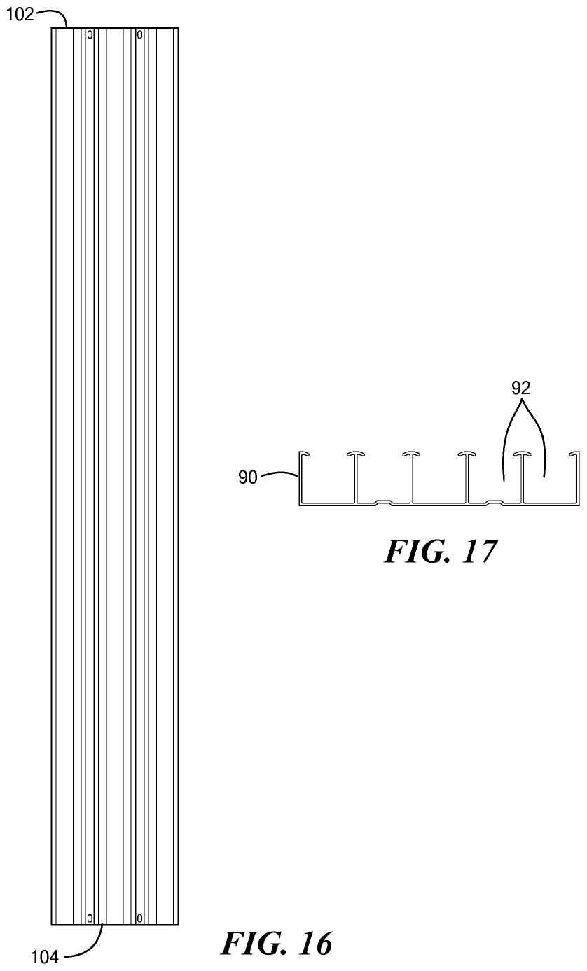

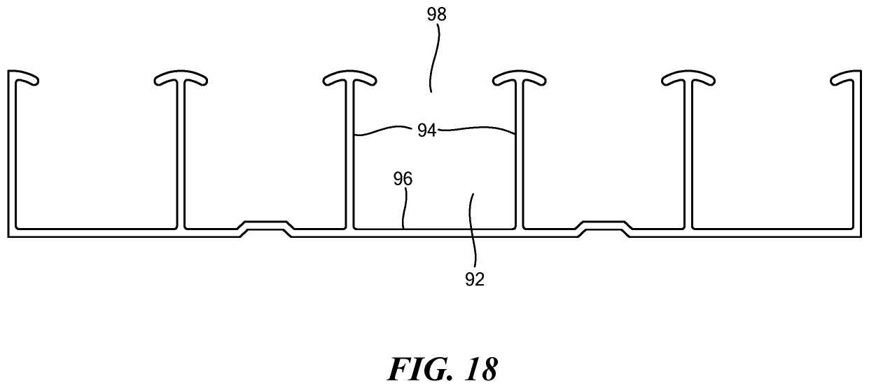

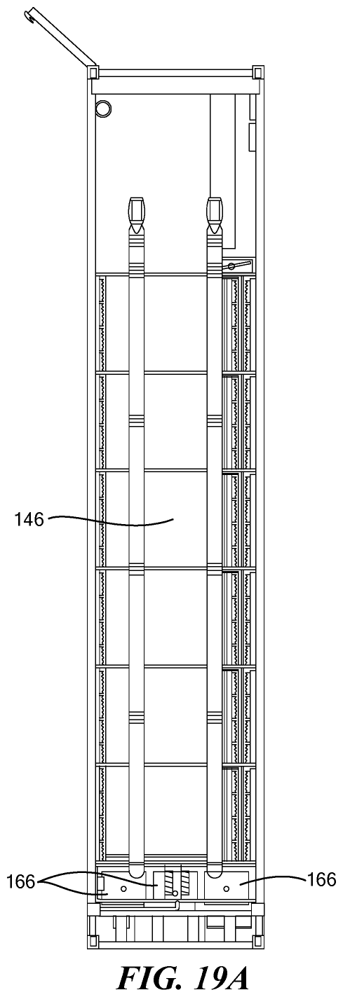

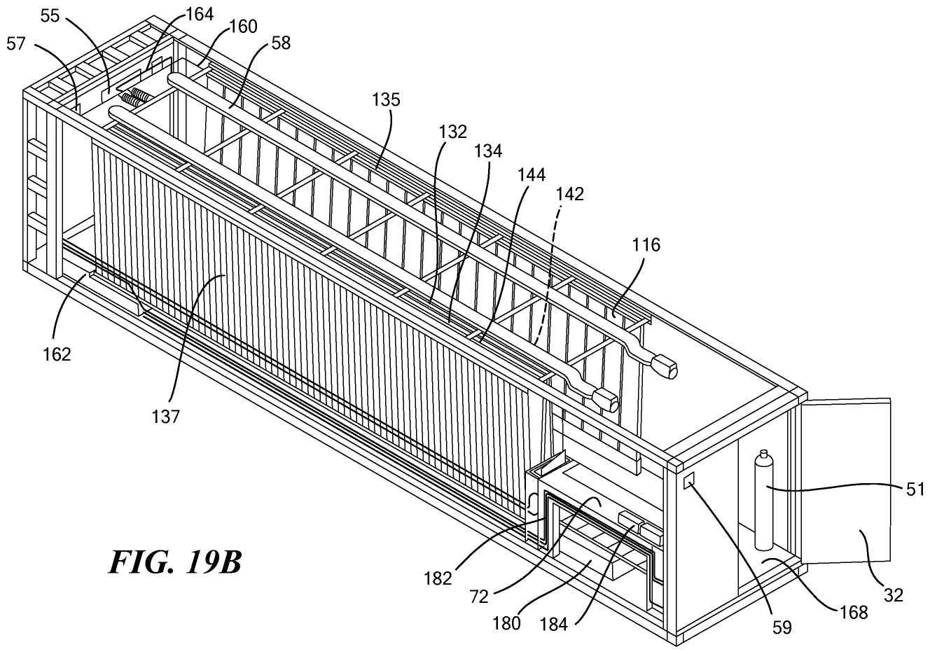

In some embodiments, each plant panel 90 can have a plurality of adjacent elongated grow channels. Referring to FIGS. 13-18, in some embodiments, each plant panel can be integrally formed to include a number of vertical grow channels. Five grow channels are shown in the embodiment illustrated; it will be appreciated that any desired number can be provided. Each grow channel can include two side walls 94, a back wall 96, and an open front face 98. Each channel is open at, or includes openings at, the top end 102 and the bottom end 104. In some embodiments, tabs can be located along the front edges of the side walls to assist in retaining a plant support substrate within the channel and/or to provide stiffening to the side walls. In some embodiments, stiffening beads can be located along the front edges of the side walls. The channels can have any cross-sectional shape, such as square, rectangular, U-shaped, C-shaped, oval, or the like. The plant panel can be made of a polymer material that is non-toxic to plants, such as food grade high density polyethylene or polyvinyl chloride. Other materials can be used. The material can be non-metallic to minimize weight. The plant panel can be formed in any suitable manner, such as by extrusion, molding, or additive manufacturing.

A plant support substrate or support medium 106 is located within each channel. The plant support substrate can be a single piece of material having a continuous slit or a plurality of discrete slits along its length in alignment with the channel, or can be formed from two pieces of material compressed together. The plant support substrate can be retained within the channel by the resiliency of the channel walls compressing against the plant support medium. Seedling plugs are placed in the slit or slits within or between the support medium. A liquid nutrient solution from an irrigation system is fed into each grow channel through the open top end and drips out the open bottom end, irrigating the plants within the grow channel as it flows downwardly through the plant support medium.

In some embodiments, the plant support substrate can be an open cell foam or matrix material with a large pore volume. In some embodiments, the open cell foam material is a polyurethane or a polyether. Other open cell foam materials can be used, such as polyethylene, polyethylene terephthalate, polypropylene, polystyrene, polyvinyl chloride, and polyester. In some embodiments, the material can be treated, for example, with a silicone binder or coating, to minimize contact between the nutrient solution and the material. Other types of plant support media can be used, such as a fibrous growth material.

The plant panel 90 can be mounted in any suitable manner. In some embodiments, the plant panels can be suspended from an overhead suspension structure. In some embodiments, each plant panel can include a hole or holes 108 near the top for hanging on a hook or tab from the suspension structure. In some embodiments, one or more grooves 109 can be provided in the back walls to help with hanging the plant panels. In some embodiments, the plant panel can include a mounting fixture on a back side of the channels. In some embodiments, the plant panels can be mounted on the interior walls of the farm container, for example, on mounting fixtures fastened to the interior walls. In some embodiments, the interior walls can include recesses to receive the plant panels.

It will be appreciated that the plant panels can have other configurations. For example, in some further embodiments, a plurality of individual channel-shaped towers can be provided. Each tower can be individually suspended vertically from the suspension structure. Each tower can include a hole or holes near the top for hanging on a hook or tab from the suspension structure. In some embodiments, a plurality of plant panels can be arranged into a double-sided plant wall, in which the elongated grow channels are arranged in a generally back-to-back orientation to form opposite sides of the plant wall.

In some embodiments, a flexible plant panel can be formed with a support panel, a grow pocket on one face of the support panel, a nutrient flow channel on an opposite face of the support panel, and a fluid aperture in the support panel for fluid communication between the grow pocket and the nutrient flow channel. One or more openings for a hook can be provided at the top of the support panel for suspension from the suspension structure.

In some embodiments, a plant panel can be formed as a rack to support one or more receptacles. In some embodiments, the rack can include one or more shelves on which a receptacle can be placed. The shelves can be attached via one or more vertical rods to a hanging fixture. In some embodiments, the receptacle can be a bag or closed receptacle that can contain an inoculated substrate suitable for growing fungi including mushrooms. In some embodiments, the receptacle can be a pot configured for a desired plant.

### 6. Lighting Systems

In some embodiments, a lighting system 110 can include lights 112 mounted along a central row located below a suspension system 130. See FIGS. 5-12. The suspension system can suspend the plant panels with plants facing toward the lights provided on the side walls and the central row. In this manner, the lights can be placed sufficiently close to the growing plants.

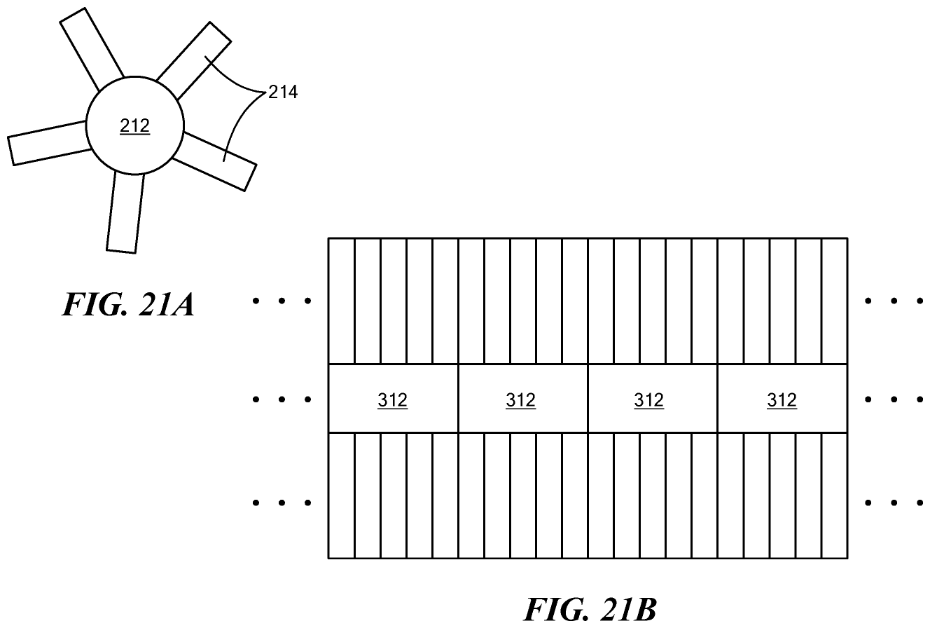

In some embodiments, the light fixtures can be provided as a panel 116 including a number of LED light strips 118 supported on opposite sides, or on one side, of a substrate panel 122. See FIG. 20. In some embodiments, the substrate panel can be made from a low gauge aluminum or aluminum alloy. The LED light strips can be arranged in horizontal rows or vertical columns on the substrate panel. Light strips of different colors can be combined and arranged according to the needs of certain plants. In the embodiment illustrated, alternating red (R) and blue (B) LED light strips are shown. The substrate panel can be mounted in any suitable manner, such as by suspension from an overhead suspension system. For example, one or more openings can be provided at the top of the substrate panel for mounting from a hook or tab from the suspension structure.

Other light fixture arrangements can be used. For example, in some embodiments, the lights can be provided as LED light curtains.

The lights can be selected for appropriate frequencies. The lights can be selected for a particular crop. In some embodiments, a mixture of frequencies, such as of blue lights and red lights, can be provided. In some embodiments, blue lights can be provided, for example, for mushrooms. In some embodiments, lights can be provided on a timer so that the plants can spend some time in darkness.

White work lights can be provided for when a farmer is working inside the work zone and/or the grow zone within the farm container. In one embodiment, the white lights can be provided as horizontal LED light strips near the ceiling. The white lights can be operated by a switch located in the work zone, so that a farmer can turn them on and off as needed. The white lights can be operated on a timer, so that they will turn off automatically after a period of time. The white lights can be operated with a motion sensor, so that they will turn on when motion, such as a farmer entering the work zone, is detected and will turn off after a period of time when no motion has been detected.

### 7. Movable Suspension Systems

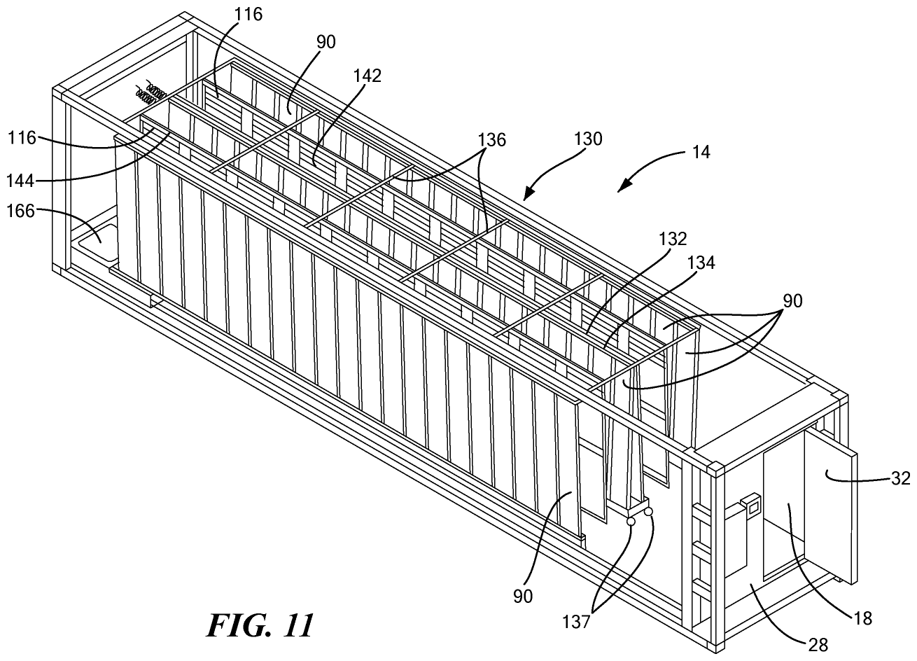

In some embodiments, the plant panels 90 and the light panels 116 can be mounted from a suspension system 130. See FIGS. 11, 19A, and 19B. The center rows 132, 134 of plant panels 90 and the rows 142, 144 of light panels 116 can be movable to provide access to the farmer. Outer rows 135, 137 of plant panels 90 can remain stationary at or adjacent to the side walls of the farm container. In some embodiments, the suspension system can include one or more cross rails 136 extending across the width of the farm container. The center plant panels and light panels can be mounted a trolley system, for example rollers or wheels that travel along a track formed on, in, or by the cross rail 136, to move along the cross rails. In some embodiments, the plant panels and/or the light panels can include wheels 137 along the bottom to ease movement across the floor. In this manner, a farmer can move the center plant panels and light panels to one side or the other side to provide more room 146 within the grow zone. For example, a farmer can make use of additional room to hang plant panels, to transplant crops, or to harvest mature crops. For example, the rows of plant panels and light panels can be spaced at generally equal intervals across the width (shorter dimension) of the farm container, all the way on one side (e.g., the right), all the way to the other side (e.g., the left), or can be bunched, for example to the leave the center open. The suspension system can be motorized and/or operable by hand. It will be appreciated that other assembly structures to move the plant panels and/or the light panels can be provided in lieu of or in addition to the suspension system described herein.

### 8. Irrigation Systems

Each farm container includes an irrigation system 160 for supplying water and nutrients to the crops. The irrigation system can include a reservoir 162 for holding a liquid nutrient solution, and can include an irrigation line extending from a pump in the reservoir upward to a location about the top ends of the plant panels. In some embodiments, the reservoir can include one or more main tanks located below the floor of the farm container. In some embodiments, the main tanks can be located at the rear of the farm container, opposite the hub container. In the embodiment shown, each farm container includes three 165 gallon tanks 166. It will be appreciated that the size and number of tanks can vary depending on the size of the farm container, the size and type of crop, and the like. In some embodiments, the farm containers can be elevated or raised above the ground or other supporting surface to provide access to valving on the underside.

The irrigation line can feed into a piping assembly 164 supported above the plant panels. The piping assembly can include a length of pipe for alignment with each row of plant panels. In one embodiment, the piping assembly is arranged in generally linear configurations arranged to align with the generally linear configurations of the plant panels suspended from the suspension system. Each length of pipe includes a number of downwardly opening emitters or nozzles. Each emitter aligns with a channel in a plant panel, such that a nutrient solution can be discharged from the emitter into the open top of the channel. The nutrient solution flows downwardly along the length of the channel to nourish the plants growing therein. Excess nutrient solution is discharged from the open end at the bottom of each channel. In some embodiments, the emitters can emit a spray, for example, to mist the air around the crop. For example, misting the air around a crop of mushrooms can be useful.

The excess nutrient discharged from the plant panels is collected in a catchment below the grow zone. A grate can cover the catchment to allow the solution to pass into the catchment. The grate can also provide a floor surface in the grow zone. A farmer can step on the grate if necessary. The grate can be removable. The catchment can be sloped to allow the nutrient solution to drain back to the reservoir.

An access opening 168 for the reservoir can be formed in the floor surface. An incoming water line and drain line can be provided, for example, below the floor surface of the farm container from the hub container. Appropriate plumbing fittings for water piping or hosing and drain line can be provided on the exterior of the hub container, as noted above. In this manner, water can be introduced into and removed from the reservoir in the container.

### 9. Farm Container Work Zone

As noted above, each farm container includes a work zone 70 in which various tasks and activities can be performed. In some embodiments, a seedling station (described further below) for planting and germinating seedlings can be located in the work zone. After the seedlings have grown sufficiently, they can be transplanted into the plant panels 116 and moved into the grow zone 80 to grow to maturity. In some embodiments, plant panels can be removed from the grow zone and carried into the work zone to harvest mature plants and to transplant seedlings into the grow channels. In some embodiments, crops such as micro greens can be grown in the work zone, for example in pots on shelving or a work surface. Other activities can be performed in the work zone. For example, maintenance tasks, such as cleaning tools and equipment, can be performed in the work zone. Equipment such as sensors, nutrient canisters, control panels, air handling units and the like can also be located within the work zone where they are accessible to a farmer. The work zone can include one or more work surfaces, shelves for storage, and a sink.

### 10. Nutrient Dosing Systems

The modular farm can include the nutrient dosing system 180, in which appropriate amounts of nutrients can be added to water in the reservoir to form the liquid nutrient solution that is fed to the growing plants. In some embodiments, the nutrient dosing system can be mounted on an interior wall of the container, such as below or adjacent to the seedling station. In some embodiments, the nutrient dosing system includes a recirculation line 182 that cycles a liquid nutrient solution from the reservoir through the dosing system and returns it to the reservoir. A sensor assembly 184 in the recirculation line includes sensors (sometimes termed “hydro sensors”) to sense various parameters, such as pH, electrical conductivity, and temperature. If any adjustments are needed, the needed additives can be added to the recirculation line, based on the output of the sensor assembly.

In some embodiments, the nutrient dosing system can be housed within the work zone. The recirculation line can be routed past the sensor assembly and to a discharge line extending downwardly to the reservoir. A plurality of nutrient sources can be provided in canisters located within the work zone. A dosing tube can lead from each canister, through a metering device, such as a peristaltic pump, to an inlet in the discharge line, for example, via delivery barbs. When the sensor assembly determines that a particular nutrient or additive is needed, the associated metering device is actuated to add an appropriate amount. In some embodiments, the sensor assembly can include a controller that actuates the metering devices to introduce an appropriate amount of the additive based on the sensed data.

In some embodiments, one canister can include a mixture of minerals suitable for growing crops, such as phosphorus, potassium, nitrogen, calcium, and nitrates. A second canister can include an additive to adjust the pH. A third canister can include mycorrhizae, which can be helpful for root growth. A fourth canister can include a cleaning solution, which can periodically be circulated through the lines. Any number of canisters and desired nutrients can be provided. In some embodiments, a viewing slot can be provided for checking on the level of nutrient in each canister. A delivery port can be provided at the top of each canister for adding more nutrient when needed or replacing an empty canister with a full one.

In some embodiments, the liquid nutrient solution can be continuously or periodically recirculated through the nutrient dosing system, so that the amount of nutrients can be monitored continuously or periodically. In this manner, the nutrient solution in the reservoir can be maintained with appropriate nutrient levels.

### 11. Seedling Stations

Referring to FIGS. 5-8, in some embodiments, a seedling station 72 can be mounted on an interior wall of the container in the work zone of each farm container. Referring to FIGS. 9-12, in some embodiments, one or several seedling stations can be mounted on an interior wall of the hub container. In this case, the planting and germination of seedlings can occur in the shared work space within the hub container.

In some embodiments, the seedling station can include a top work shelf 73 on which a seedling tray can be placed while a farmer works on it to plant seed or move seedlings to a plant panel. One or more lower shelves 75 contain water troughs for supplying water to seedling plugs placed in a seedling tray in which seedlings grow. Each trough shelf can include tubing for filling and draining the trough with the nutrient solution from the reservoir. A bottom floor of the trough can be sloped so that water is directed across the surface from a high end to a low end. In some embodiments, nutrient solution can enter from the fill tubing at the high end and flow along the slope to the low end, where drain tubing can be located. In some embodiments, a seedling tray can include a top wall having a plurality of openings therein in which seedling plugs sit so that the bottom of each plug reaches the trough floor to access the nutrient solution when placed on the water trough shelf. The seedling tray can also include a handle along a front edge that fits within a supporting groove on the top work shelf to prevent the tray from moving about when a farmer is working on it. When the seedling tray is placed on the trough shelf, the handle overhangs the edge of the trough.

A seedling pump can be provided for each water trough shelf to provide the nutrient solution to the seedlings. The seedling pumps can be located in the reservoir beneath the floor of the work zone. The fill and drain tubing to and from the seedling pumps extends within a wall portion of one of the container walls. Lights can be mounted beneath the work shelf and the upper trough shelf to provide light for seedlings on the trough shelves.

### 12. Control Systems

In some embodiments, various parameters of the containers and the environment therein can be controlled to be optimized for a particular crop that is desired to be grown in the container. The control of the farm environment can be automated and can be controlled by a suitable control system. A central control system can be provided to allow a farm to select a particular farm container or subset of farm containers, for example, via a drop down menu or the like. The central control system can include automation of shared operations, such as climate control. In some embodiments, a control system can be provided to schedule movement of the plant panels and operation of the lights. Sensor readings can be transmitted to the control system, which can determine whether adjustments are needed. The control system or a portion thereof can be located within each farm container separately. The control system can be located within the hub container. The control system can be located remotely or both remotely and at the farm containers and/or the hub container. For example, in some embodiments, an app that can run on a device such as a smart phone can be used to alert a farmer to various parameters, to send photographs, and to allow the farmer to control the systems to adjust and optimize the growing conditions within one or more farm containers.

The climate control system can include control of the HVAC system for the farm container(s) and the hub container. The climate control system can be operative to maintain the climate within a selected range of parameters, which can vary depending on the particular crop being grown in the container.

The control system can be implemented as software- and hardware-based tools for controlling and monitoring modular farm systems as described herein. For example, the farm control system can be implemented as or can include one or more computing devices that include a combination of hardware, software, and firmware that allows the computing device to run an applications layer or otherwise perform various processing tasks. Computing devices can include without limitation personal computers, work stations, servers, laptop computers, tablet computers, mobile devices, hand-held devices, wireless devices, smartphones, wearable devices, embedded devices, microprocessor-based devices, microcontroller-based devices, programmable consumer electronics, mini-computers, main frame computers, and the like.

The computing device can include a basic input/output system (BIOS) and an operating system as software to manage hardware components, coordinate the interface between hardware and software, and manage basic operations such as start up. The computing device can include one or more processors and memory that cooperate with the operating system to provide basic functionality for the computing device. The operating system provides support functionality for the applications layer and other processing tasks. The computing device can include a system bus or other bus (such as memory bus, local bus, peripheral bus, and the like) for providing communication between the various hardware, software, and firmware components and with any external devices. Any type of architecture or infrastructure that allows the components to communicate and interact with each other can be used.

Processing tasks can be carried out by one or more processors. Various types of processing technology can be used, including a single processor or multiple processors, a central processing unit (CPU), multicore processors, parallel processors, or distributed processors. Additional specialized processing resources such as graphics (e.g., a graphics processing unit or GPU), video, multimedia, or mathematical processing capabilities can be provided to perform certain processing tasks. Various learning algorithms can be implemented. Processing tasks can be implemented with computer-executable instructions, such as application programs or other program modules, executed by the computing device. Application programs and program modules can include routines, subroutines, programs, drivers, objects, components, data structures, and the like that perform particular tasks or operate on data.

Processors can include one or more logic devices, such as small-scale integrated circuits, programmable logic arrays, programmable logic device, masked-programmed gate arrays, field programmable gate arrays (FPGAs), and application specific integrated circuits (ASICs). Logic devices can include, without limitation, arithmetic logic blocks and operators, registers, finite state machines, multiplexers, accumulators, comparators, counters, look-up tables, gates, latches, flip-flops, input and output ports, carry in and carry out ports, and parity generators, and interconnection resources for logic blocks, logic units and logic cells.

The computing device includes memory or storage, which can be accessed by the system bus or in any other manner. Memory can store control logic, instructions, and/or data. Memory can include transitory memory, such as cache memory, random access memory (RAM), static random access memory (SRAM), main memory, dynamic random access memory (DRAM), and memristor memory cells. Memory can include storage for firmware or microcode, such as programmable read only memory (PROM) and erasable programmable read only memory (EPROM). Memory can include non-transitory or nonvolatile or persistent memory such as read only memory (ROM), hard disk drives, optical storage devices, compact disc drives, flash drives, floppy disk drives, magnetic tape drives, memory chips, and memristor memory cells. Non-transitory memory can be provided on a removable storage device. A computer-readable medium can include any physical medium that is capable of encoding instructions and/or storing data that can be subsequently used by a processor to implement embodiments of the method and system described herein. Physical media can include floppy discs, optical discs, CDs, mini-CDs, DVDs, HD-DVDs, Blu-ray discs, hard drives, tape drives, flash memory, or memory chips. Any other type of tangible, non-transitory storage that can provide instructions and/or data to a processor can be used in these embodiments.

The computing device can include one or more input/output interfaces for connecting input and output devices to various other components of the computing device. Input and output devices can include, without limitation, keyboards, mice, joysticks, microphones, displays, touchscreens, monitors, scanners, speakers, and printers. Interfaces can include universal serial bus (USB) ports, serial ports, parallel ports, game ports, and the like.

The computing device can access a network over a network connection that provides the computing device with telecommunications capabilities. Network connection enables the computing device to communicate and interact with any combination of remote devices, remote networks, and remote entities via a communications link. The communications link can be any type of communication link, including without limitation a wired or wireless link. For example, the network connection can allow the computing device to communicate with remote devices over a network, which can be a wired and/or a wireless network, and which can include any combination of intranet, local area networks (LANs), enterprise-wide networks, medium area networks, wide area networks (WANs), the Internet, cellular networks, and the like. Control logic and/or data can be transmitted to and from the computing device via the network connection. The network connection can include a modem, a network interface (such as an Ethernet card), a communication port, a PCMCIA slot and card, or the like to enable transmission of and receipt of data via the communications link.

The computing device can include a browser and a display that allow a user to browse and view pages or other content served by a web server over the communications link. A web server, server, and database can be located at the same or at different locations and can be part of the same computing device, different computing devices, or distributed across a network. A data center can be located at a remote location and accessed by the computing device over a network.

The computer system can include architecture distributed over one or more networks, such as, for example, a cloud computing architecture. Cloud computing includes without limitation distributed network architectures for providing, for example, software as a service (SaaS), infrastructure as a service (IaaS), platform as a service (PaaS), network as a service (NaaS), data as a service (DaaS), database as a service (DBaaS), desktop as a service (DaaS), backend as a service (BaaS), test environment as a service (TEaaS), API as a service (APIaaS), and integration platform as a service (IPaaS).

### 13. Container Structures

The hub container 12 and farm containers 14 can have any configuration and can be formed in any suitable manner. In some embodiments, each container is formed with four wall panel assemblies, a roof panel assembly, and a floor panel assembly supported by suitable framing. The panel assemblies can be made from any suitable material(s). In one embodiment, the panels can be thermally insulated with, for example, a fiberglass or other insulating material between inner and outer panels. The inner and outer panels can be formed of a fiberglass material. The inner and outer panels of each panel assembly can be shaped or configured as desired.

In some embodiments, one wall, such as an end wall, can be formed form a glass panel 201. The glass panel allows people to view inside the container while remaining outside, which can minimize contamination of the crops growing within the container and disruption of a farmer working within the container.

The container can be framed in any suitable manner. In one embodiment, the framing can include columns or corner castings 204 at each corner and beams 206 connecting the columns at their upper and lower ends. Floor and ceiling frame elements can be spaced to allow for placement of various pieces of equipment. Framing and other structural members can be made of any suitable material, such as a metal, for example, steel. The panels can be fastened to the framing elements in any suitable manner. Drainage holes can be provided in suitable locations in the floor, such as at each corner of the container. Drainage holes 208 provide an exit for any spills or water used when cleaning the farm container or the like. Adjacent containers can be connected together for stability in any suitable manner, such as with lock nuts.

In some embodiments the hub and/or farm containers are new or used freight containers. The freight containers can be of any standard size, and can all be of the same size or different sizes can be mixed within a system. The freight containers can be adapted as needed to provide the subsystems used in a modular farm system.

Service lines for irrigation and electrical power can be provided in void spaces, for example, in the ceiling, floor, and walls. Controls, such as switches and the like, for operating the various systems, such as the lighting system, the suspension system, and the irrigation system, can be included within the work zone of the farm containers or the hub container for operation by the farmer. For example, the farmer can control a motor of the suspension system to move a desired plant panel or light panel to a location for access from the work zone.

While described as a “container,” it will be appreciated that the hub container and farm containers do not have to be actual shipping containers, although they can be if desired. In some embodiments, fully assembled containers can be transported to the desired site and set in place on a suitable foundation and connected to adjacent containers. In some embodiments, the containers can be assembled from their constituent parts on site. In some embodiments, the farm containers can include one or more refrigerant or refrigerated containers, sometimes termed reefer containers.

The modular farm system described herein can be used to grow a large variety of crops, particularly green, leafy plants. For example, the device can be used to grow leafy greens, such as lettuce, spinach, chard; brassicas, such as broccoli, cabbage, cauliflower, Brussels sprouts, kohlrabi, mustard, kale, arugula; and herbs such as basil, oregano, parsley, mint, rosemary, thyme, and chive. Other crops can include tomatoes, peppers, strawberries, cucumbers, flowers, root vegetables, vine crops, and mushrooms. The modular farm can be used for seed germination, post germination plant growth, or post seedling plant growth. Any suitable growing medium or plant support medium can be used, depending on the particular crop. As used herein, the terms “plant” or “plants” can include fungi, including mushrooms.

As used herein, “consisting essentially of” allows the inclusion of materials or steps that do not materially affect the basic and novel characteristics of the claim. Any recitation herein of the term “comprising,” particularly in a description of components of a composition or in a description of elements of a device, can be exchanged with “consisting essentially of” or “consisting of.”

It will be appreciated that the various features of the embodiments described herein can be combined in a variety of ways. For example, a feature described in conjunction with one embodiment may be included in another embodiment even if not explicitly described in conjunction with that embodiment.

The present technology has been described in conjunction with certain preferred embodiments. It is to be understood that the technology is not limited to the exact details of construction, operation, exact materials or embodiments shown and described, and that various modifications, substitutions of equivalents, alterations to the compositions, and other changes to the embodiments disclosed herein will be apparent to one of skill in the art.

1. A modular farm system comprising:
a hub container, a plurality of farm containers connected to the hub container, and a user passageway between the hub container and each farm container, wherein:
the hub container includes a shared workspace and at least one shared utility for distribution among the plurality of farm containers;
each farm container includes a work zone and a grow zone located therein, a plurality of plant panels mounted for growing plants within the grow zone, and a lighting system disposed in the grow zone to provide light for plants growing in the plant panels.

2. The modular farm system of claim 1, wherein the work zone in one or more of said farm containers includes one or more of a seedling station, nutrient solution sensors, nutrient canisters, a control panel, and air handling unit.

3. The modular farm system of claim 1, wherein the work zone in one or more of said farm containers includes a seedling station for the germination of seeds.

4. The modular farm system of claim 1, wherein the shared workspace in the hub container includes one or more seedling stations for the germination of seeds.

5. The modular farm system of claim 3, wherein the seedling station includes a trough to hold seedlings and a nutrient dosing system configured to provide a flow of a liquid nutrient solution to the seedlings in the trough.

6. The modular farm system of claim 1, wherein the shared workspace in the hub container includes a packaging station including a work surface for packaging harvested mature plants from one or more of the plurality of farm containers.

7. The modular farm system of claim 1, wherein the at least one shared utility of the hub container includes a climate control system comprising a split air conditioning and heating system including a condensing unit disposed at the hub container and an air handling unit disposed at each of the plurality of farm containers.

8. The modular farm system of claim 7, wherein the climate control system comprises a ductless system including conduits from the condensing unit to each of the air handling units, the conduits including a power cable and refrigerant tubing, or a ducted system including ductwork for a flow of conditioned air to each of the farm containers.

9. The modular farm system of claim 1, wherein the at least one shared utility of the hub container includes an electrical power input hookup and wiring to each or a subset of the plurality of farm containers, the wiring being distributed into at least two separate zones.

10. The modular farm system of claim 1, wherein the at least one shared utility of the hub container includes an incoming water connection and outgoing drain connection, the water connection and the drain connection in fluid communication with an irrigation system in each farm container.

11. The modular farm system of claim 1, wherein each farm container includes a plurality of plant panels arranged in rows extending a length of the farm container, and a plurality of light panels arranged in rows facing each of the rows of the plant panels.

12. The modular farm system of claim 11, further comprising a suspension system in each of the plurality of farm containers configured to suspend one or both of the plurality of plant panels and the plurality of light panels.

13. The modular farm system of claim 12, wherein the suspension system includes a trolley system to provide movement of at least a portion of the plant panels or the light panels or both a portion of the plant panels and the light panels.

14. The modular farm system of claim 1, wherein each plant panel comprises a plurality of adjacent, integrally formed elongated channels, and a mounting fixture disposed on a back wall of the plant panel configured to removably suspend the plant panel from the suspension system.

15. The modular farm system of claim 1, further comprising an irrigation system within each farm container, the irrigation system including:
a nutrient solution reservoir disposed in the farm container;
an irrigation line disposed to deliver a liquid nutrient solution from the nutrient solution reservoir to an upper end of each plant panel; and
a pump in the nutrient solution reservoir connected to the irrigation line.

16. The modular farm system of claim 15, wherein the irrigation system further includes a plurality of emitters on the irrigation line, each emitter being disposed above an elongated channel in each of the plant panels, and each elongated channel having an open upper end to receive a liquid nutrient solution from an associated emitter.

17. The modular farm system of claim 16, wherein each elongated channel of the plant panels has an open lower end to discharge liquid nutrient solution to return to the nutrient solution reservoir.

18. The modular farm system of claim 15, wherein the irrigation system in each farm container is in fluid communication with an incoming water line having an input connection at the hub container and a drain line having an output connection at the hub container.

19. The modular farm system of claim 1, further comprising a nutrient dosing system in each of the plurality of farm containers, comprising:
a recirculation line disposed to recirculate a liquid nutrient solution from a nutrient solution reservoir,
a plurality of nutrient sources, and
a line from each nutrient source to the recirculation line to introduce a nutrient into the recirculation line.

20. The modular farm system of claim 19, wherein the nutrient dosing system further comprises a sensor assembly disposed to sense one or more of pH, electrical conductivity, and temperature of a liquid nutrient solution in the recirculation line.

21. The modular farm system of claim 1, further comprising a control system for automating control of a growing environment within each farm container, the control system including one or more processors and memory, and machine-readable instructions stored in the memory that, upon execution by the one or more processors cause the system to carry out operations comprising:
receiving communications from one or more of the plurality of farm containers, the communications including at least data from one or more of a sensor and equipment within the farm container; and
transmitting a communication to at least one of the farm containers comprising instructions or notifications regarding growing conditions within the contained environment.

22. The modular farm system of claim 21, wherein the control system is further operative to carry out operations including receiving communications from the hub container including at least data from one or more or a sensor and equipment within one or more of the farm containers, and transmitting a communication to a selected one of the farm containers through the hub container.

23. The modular farm system of claim 22, wherein the transmitted communication includes instructions to carry out operations comprising controlling and monitoring one or more of a lighting system, an irrigation system, and a climate control system within the farm container.

24. The modular farm system of claim 1, wherein each of the hub container and the farm containers are rectangular in plan and the farm containers each have a shorter wall disposed adjacent a longer wall of the hub container, each of the farm containers being disposed with a longer wall adjacent to a longer wall of an adjacent farm container.

25. The modular farm system of claim 1, wherein the hub container extends for a linear distance, and the plurality of farm containers are disposed to extend orthogonally to the linear distance of the hub container on one or both sides of the hub container.

26. The modular farm system of claim 1, wherein the hub container has a polygonal configuration and the plurality of farm containers extend radially from sides of the polygonal configuration of the hub container.

27. The modular farm system of claim 1, further comprising an additional hub container connected to the hub container for user passage therethrough, and an additional plurality of farm containers connectable to the additional hub container, a user passageway extending between the additional hub container and each additional farm container.

28. The modular farm system of claim 1 comprising two or more hub containers, each hub container being connected via a passageway to each of a separate plurality of farm containers.

29. The modular farm system of claim 28, wherein the two or more hub containers are connected via one or more passageways.

30. The modular farm system of claim 28, wherein the system comprises two or more separate zones, each zone comprising one or more farm containers or one or more hub containers, each with its associated farm containers, and wherein the separate zones are configured for different crops, different plant growth conditions, or different customers.

31. The modular farm system of claim 30, wherein the separate zones are configured for different growth conditions, and the different growth conditions differ according to lighting, temperature, nutrient solution, humidity, plant density, or CO₂ concentration.

32. A method of growing a crop, comprising:
providing the modular farm system of claim 1;
growing a crop within at least one of the plurality of farm containers.

33. The method of growing a crop of claim 32, further comprising germinating seedlings in a seedling station disposed in one or both of the shared workspace of the hub container or the work zone of the farm containers, and planting seedlings in the grow space in one or more of the plurality of farm containers.

34. The method of growing a crop of claim 32, further comprising harvesting a mature crop from one or more of the plurality of farm containers, and packaging the mature crop at a packaging station in the shared workspace of the hub container.
